(19) United States
(12) Patent Application Publication
(10) Pub. No.: US 2013/0222232 A1
(43) Pub. Date: Aug. 29, 2013

(54) GESTURE RECOGNITION DEVICE AND METHOD THEREOF

(71) Applicant: PANTECH CO., LTD., (US)

(72) Inventors: Boung-Hun KONG, Seoul (KR); Kang-Suk CHOI, Seoul (KR); Jong-Gon KIM, Seoul (KR)

(73) Assignee: PANTECH CO., LTD., Seoul (KR)

(21) Appl. No.: 13/693,628

(22) Filed: Dec. 4, 2012

(30) Foreign Application Priority Data
Feb. 24, 2012 (KR) 10-2012-0019290

(51) Int. Cl. G06F 3/01

(52) U.S. Cl. CPC G06F 3/011
USPC 345/156

(57) ABSTRACT

A device and a method having a gesture recognition operation at a distance are provided. The device to recognize a gesture of a user includes an image capture unit to capture a gesture to acquire image information, a control unit to determine a distance between the device and the user based on the image information, and to determine a mode of the device according to the determined distance. The method for recognizing a gesture for a device includes capturing a gesture of a user as image information, determining a distance between the device and the user based on the image information, and determining a mode of operation according to the determined distance.

### CROSS-REFERENCE TO RELATED APPLICATION

This application claims the benefit under 35 U.S.C. §119(a) of a Korean Patent Application No. 10-2012-0019290, filed on Feb. 24, 2012, the entire disclosure of which is incorporated herein by reference for all purposes.

### BACKGROUND

1. Field

The following description relates to user interface technology, and more particularly, to a technique of recognizing user gestures.

2. Description of the Background

In general, devices receive user operation signals via keypads, touchpads, or the like. However, as devices become more diverse and highly utilized, research is progressing into securing device usability even in environments in which it is difficult to use the keypad or the touchpad. For example, user gestures may be recognized and corresponding operations may be carried out. However, this is limited to recognition of user gestures at short distances between the user and the device. Meanwhile, as kinds and functions of devices become more diverse, users are trying to link different devices and their various functions.

### SUMMARY

Exemplary embodiments of the present invention provide a device and a gesture recognition method that can increase the accuracy of recognizing user gestures regardless of the distance between the user and the device.

Additional features of the invention will be set forth in the description which follows, and in part will be apparent from the description, or may be learned by practice of the invention.

Exemplary embodiments of the present invention provide a device to recognize a gesture of a user, the device including: an image capture unit to capture a gesture to acquire image information; a control unit to determine a distance between the device and the user based on the image information, and to determine a mode of the device according to the determined distance.

Exemplary embodiments of the present invention provide a method for recognizing a gesture for a device, the method including: capturing a gesture of a user as image information; determining a distance between the device and the user based on the image information; and determining a mode of operation according to the determined distance.

Exemplary embodiments of the present invention provide a method for recognizing a gesture for a device, the method including: entering a capture-based gesture recognition mode according to at least one of establishing a connection to another device, mounting the device on a device rest, and executing an application; capturing a gesture of a user as image information; determining a distance between the device and the user based on the image information; determining a mode of operation of the device based on the determined distance; and determining regions of the image information associated with a gesture if the a mode of operation of the device is determined to be a long distance mode.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating a device according to exemplary embodiments of the present invention.

FIG. 2 is a diagram illustrating a detailed configuration of a control unit according to exemplary embodiments of the present invention.

FIG. 3 is a diagram illustrating a configuration of a software stage operating on a device according to exemplary embodiments of the present invention.

FIGS. 4 and 5 are reference diagrams illustrating environments for gesture recognition according to exemplary embodiments of the present invention.

FIG. 6 is a reference diagram illustrating an environment for gesture recognition according to exemplary embodiments of the present invention.

FIG. 7 is a reference diagram illustrating setting a capture-based gesture recognition mode event according to exemplary embodiments of the present invention.

FIG. 8A and FIG. 8B are reference diagrams illustrating image screens in which gesture regions of a device are determined according to exemplary embodiments of the present invention.

FIG. 9 is a diagram illustrating an image screen for setting a gesture region of a device according to exemplary embodiments of the present invention.

FIGS. 10A and 10B are diagrams illustrating user gesture recognition according to exemplary embodiments of the present invention.

FIG. 11 is a flowchart illustrating a gesture recognition method of a device according to exemplary embodiments of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that when an element is referred to as being “connected to” another element, it can be directly connected to the other element, or intervening elements may be present. Further, it will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

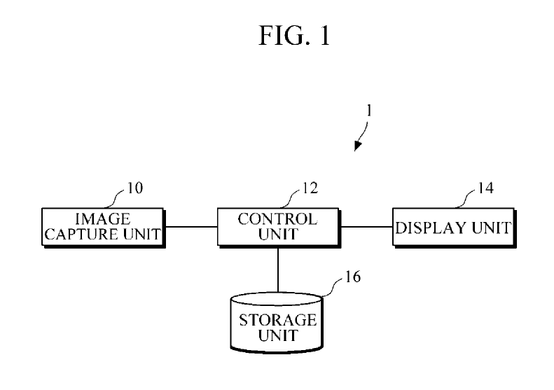

FIG. 1 is a diagram illustrating a device according to exemplary embodiments of the present invention.

A device 1 includes an image capture unit 10, a control unit 12, a display unit 14, and a storage unit 16. The device 1 may be a terminal, such as a mobile terminal, cellular telephone, smartphone, personal digital assistant (PDA), tablet computer, laptop computer, desktop computer, and the like. However, aspects need not be limited thereto such that features may be implemented in a display device or television as well.

The device 1 may recognize gestures of a user, and in particular, improves a user gesture recognition rate at a distance. The device 1 captures a gesture of the user using an image capture unit 10 to recognize the user located at a distance. The device then recognizes the gesture of the user made within a reference range of the captured image. It is thus possible to enhance the accuracy of the user gesture recognition at a distance.

In particular, the image capture unit 10 captures the gesture of the user to acquire image information. The image capture unit 10 may be a camera, and the image capture unit 10 may include more than one camera. The image capture unit 10 may operate at the time of entering a capture-based gesture recognition mode for recognizing the user gesture through the captured image. For example, the image capture unit 10 may enter a capture-based gesture recognition mode when the device 1 is connected to another device, when the device 1 is mounted on a device rest, or when an event set in the capture-based gesture recognition mode occurs. The capture-based gesture recognition mode event may be set or changed by the user.

The control unit 12 controls the components of the device 1. The control unit 12 uses the image information acquired through the image capture unit 10 to determine whether a distance between the device 1 and the user is a long distance or a short distance. A long distance may be a distance between the device 1 and the user sufficient for the device 1 to recognize a body and a face of the user whereas the short distance may be a distance between the device 1 and the user sufficient for the device to recognize only a face of the user; however, aspects need not be limited thereto such that such determination may be predetermined and/or set by the user. The determination standard may be variously set. When the distance is the long distance, the control unit may determine a gesture region for the gesture recognition and recognize the gesture occurring within the determined gesture region. The user gesture recognition rate may be improved when the distance between the device 1 and the user is long.

The display unit 14 visually displays movements or internal data in accordance with user and processor instructions. The display unit 14 may include a display, such as a Liquid Crystal Display (LCD), a Light Emitting Diode (LED) display, an Organic Light Emitting Diode (OLED) display, or the like. The display unit 14 of the present disclosure may display the image that is captured for user convenience when the user gesture is captured using the image capture unit 10. In this case, the user may make movements and gestures while viewing himself/herself.

The storage unit 16 stores and manages data associated with the gesture recognition. The storage unit 16 may store a series of data associated with the gesture recognition. The storage unit 16 may store the data associated with the gesture recognition while the images of the gestures are captured and/or after the gesture is recognized. The control unit 12 may read the corresponding data associated with the gesture recognition from the storage unit 16 at a later time to recognize a gesture such that the gesture recognition process time may be decreased by reading the data associated with the gesture recognition.

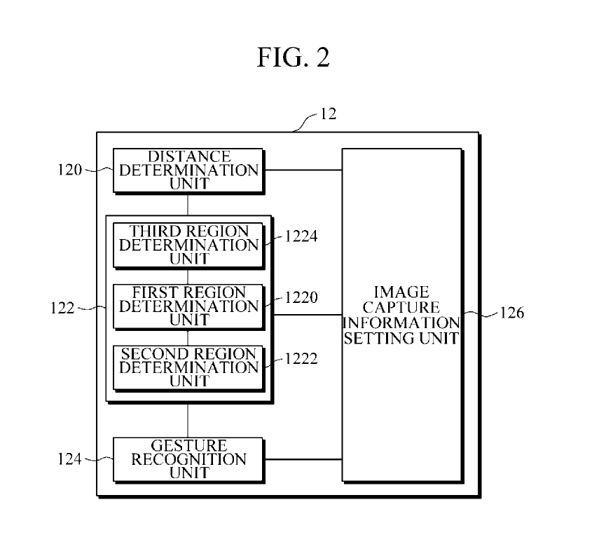

FIG. 2 is a diagram illustrating a detailed configuration of a control unit according to exemplary embodiments of the present invention. Although aspects are described with respect to the control unit 12 of the device 1, aspects need not be limited thereto.

The control unit 12 may include a distance determination unit 120, a gesture region determination unit 122, and a gesture recognition unit 124, and an image capture information setting unit 126.

The distance determination unit 120 determines a distance between the device 1 and the user from the captured image, and determines a mode between a long distance mode and a short distance mode. The mode determination may be carried out in various ways. Further, the distance determination unit 120 may determine a distance between the device 1 and a gesture recognized at a distance.

The distance determination unit 120 recognizes a face and a body in the captured image. The distance determination unit 120 determines to operate according to the short distance mode when the corresponding image includes only the face of the user, i.e., the user is located at a short distance, and determines to operate according to the long distance mode when the corresponding image includes the face and the body of the user, i.e., the user is located at a long distance. For example, in order to recognize the face, the face may be schematically extracted from the captured image, and eyes, a nose, and lips, which are characteristic components of the face, may then be extracted to recognize a face region on the basis of the extracted information. When positions of the two eyes of a face are detected, a distance between the two eyes can be obtained or determined. Further, the face region may be recognized from the captured image on the basis of the distance between the two eyes. In this case, in order to stably detect and track the face of the user located at a long distance, the distance determination unit 120 may combine results of mean shift color tracking, face detection, omega detection, and so forth, to continuously calculate positions of the face region of the user. The distance determination unit 120 may set a middle point between a centroid of the recognized face region and a centroid of the entire silhouette of the captured image as a centroid to recognize the body region.

The distance determination unit 120 may determine to operate according to the short distance mode when the distance determination unit receives a touch operation signal from the user, and may determine to operate according to the long distance mode when the distance determination unit does not receive the touch operation signal from the user.

The distance determination unit 120 may determine to operate according to the short distance mode when the device 1 is not mounted on the device rest, and may determine to operate according to the long distance mode when the device 1 is mounted on the device rest. The device 1 may recognize if that the device 1 is mounted on the device rest according to a connection to the device rest, for example, through a received or transmitted signal or current, a gyroscope, an accelerometer, and the like.

When the distance determination unit 120 determines that the device 1 enters the long distance mode, the gesture region determination unit 122 determines a range of the gesture region in which the user gesture can occur in the captured image.

The gesture region determination unit 122 includes a first region determination unit 1220 that determines a first region in the captured image. In this case, the first region may be an upper body or a face region of the user.

The gesture region determination unit 122 includes a second region determination unit 1222 that determines a second region on the basis of the first region determined by the first region determination unit 1220. In this case, the second region is a region around the first region or a region within the first region, and may be a region in which a hand movement or other movement of the user that is may be a gesture can be recognized. For example, the second region may be a hand region of the user when the first region is the upper body or the face region of the user.

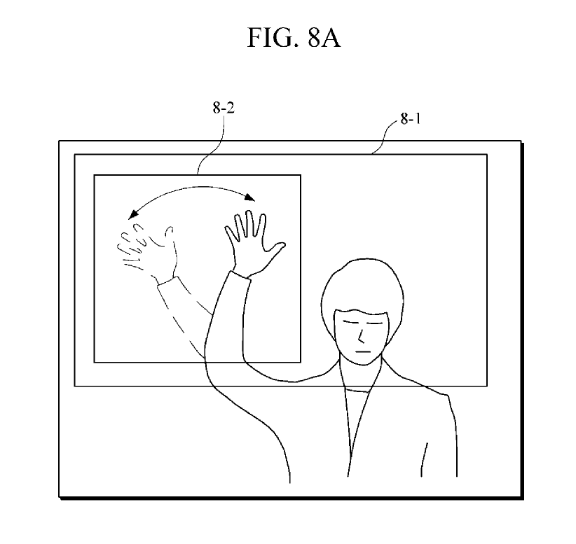

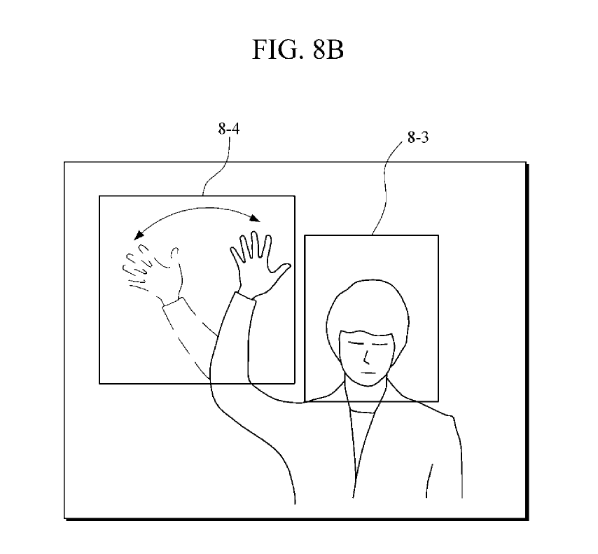

The second region determination unit 1222 may limit the distance to the second region through image focusing. Configurations of the first region determination unit 1220 and the second region determination unit 1222 may be separate or may be integrated as a single device, apparatus, or module. Examples of setting the regions of the first region determination unit 1220 and the second region determination unit 1222 will be described later in detail with reference to FIGS. 8A and 8B.

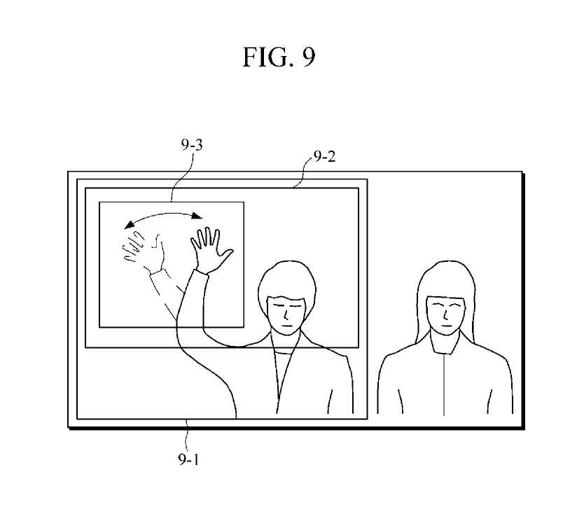

The gesture region determination unit 122 includes a third region determination unit 1224 that determines a third region in which a specific person among a plurality of persons is included when the plurality of persons is captured in the captured image. The third region determination unit 1224 may limit the third region in which the specific person is included by virtue of an auxiliary determination or input, for example gesture recognition and/or voice recognition. The first region determination unit 1220 may then determine the first region on the basis of the third region in which the specific person is determined to be included by the third region determination unit 1224. An example of setting the region of the third region determination unit 1224 will be described later in detail with reference to FIG. 9.

In addition, although the gesture region determination unit 122 may determine the third region in which the specific person among the plurality of persons is included using the third region determination unit 1224, the gesture region may be determined by the first region determination unit 1220 and/or the second region determination unit 1222 with respect to each of the plurality of persons, so that the gesture regions may be determined to be plural, i.e., the gesture region determination unit 122 may determine multiple persons to be included in the gesture region such that gestures may be recognized by the gesture recognition unit 124 from each of the plurality of persons.

The gesture recognition unit 124 recognizes the user gesture within the gesture region determined by the distance determination unit 120, and executes an instruction corresponding to the recognized gesture. The gesture recognition unit 124 determines the gesture by comparing images acquired by the image capture unit 10 in a time order, compares the determined gesture with a predetermined pattern, and executes a corresponding instruction when the determined gesture matches the predetermined pattern.

The image capture information setting unit 126 may adjust the number of frames of the image captured by the image capture unit 10 in order to increase a gesture recognition rate when the device 1 enters the capture-based gesture recognition mode. For example, the image capture information setting unit 126 may increase the number of frames of the image in the capture-based gesture recognition mode to be greater than in other operating modes. The image capture unit 10 captures the user gesture in accordance with the number of image frames set by the image capture information setting unit 126. In this case, the gesture region determination unit 122 detects the gesture region for each image frame at a regular time interval in consideration of processing efficiency, and the gesture recognition unit 124 recognizes the user gesture within the detected gesture region.

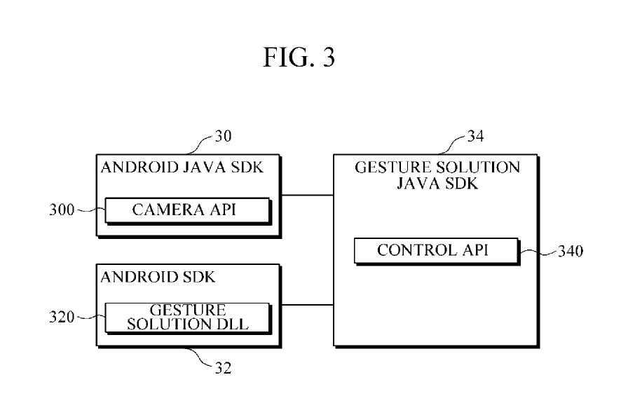

FIG. 3 is a configuration diagram illustrating a software stage operating in the device according to exemplary embodiments of the present invention. Although aspects may be described with respect to device 1 and FIGS. 1 and 2, aspects need not be limited thereto.

Device 1 may execute the gesture recognition operation described with reference to FIGS. 1 and 2. The device 1 may include software that executes or operates one or more software entities or applications in the device 1 to carry out the gesture recognition operation. A software development kit (SDK) is a collection of development tools that allow for creation of application programs for the software. The SDK includes an Application Programming Interface (API) including files for interpreting a specific programming language (e.g., JAVA) or including complicated hardware in communication with a specific embedded system.

In particular, FIG. 3 illustrates an example of code sets that allow the device 1 to carry out the gesture recognition operation of FIGS. 1 and 2. In the Android-based SDK software, a control API 340 of the gesture solution JAVA SDK 34 controls a camera API 300 of the Android JAVA SDK 30 and a gesture solution DLL 320 of the Android SDK 32 to carry out the gesture recognition operation described with reference to FIGS. 1 and 2. Meanwhile, although exemplary embodiment may be described based on the Android operating system, exemplary embodiments may be applied to other operating systems, such as iOS® or Windows Mobile OS®, when conditions for carrying out the same operations are satisfied.

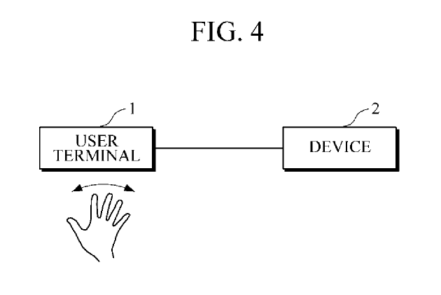

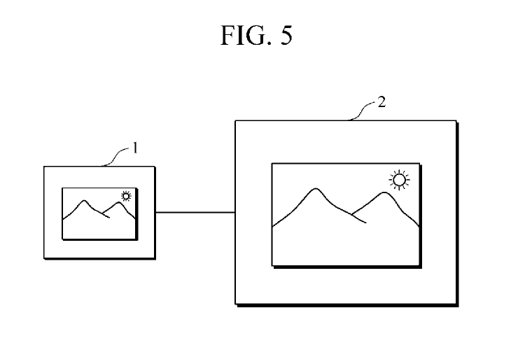

FIGS. 4 and 5 are reference diagrams illustrating environments for gesture recognition according to exemplary embodiments of the present invention.

Referring to FIG. 4, the device 1 may be connected to another device 2. For example, the device 2 may be a TV. The user may connect the device 1 to another device 2 to allow data of the device 1 to be processed by the device 2. For example, the user may view the photo stored in the device 1 via a large screen of the device 2, e.g., a TV, connected to the device 1, as shown in FIG. 5.

In general, a cable may be used to connect the device 1 and the device 2. In this case, since the length of the cable is limited, the user needs to move near the device 1 in order to make a specific movement. To increase a distance between the device 1 and the device 2, the length of the cable may be increased, or a wireless communication technique, such as Wi-Fi and the like, may be used.

When the device 1 is connected to the device 2 and the user executes a remote operation, the user gesture is captured by the image capture unit 10, the user located at a long distance is recognized, and the user gesture carried out within a predetermined range from the captured image is then recognized. It is thus possible to improve the accuracy of sensing the user gesture even when the device 1 is connected to and adjacent to or near the device 2.

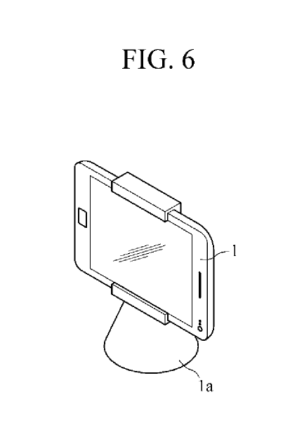

FIG. 6 is a reference diagram illustrating an environment for gesture recognition according to exemplary embodiments of the present invention.

Referring to FIG. 6, the device 1 may be mounted on a device rest 1a. For example, the device 1 may be mounted on the device rest 1a when the user does not need to carry the device 1. The device 1 may be conveniently mounted on the device rest 1a to charge the device 1 or when the user gets into a vehicle. However, when the device 1 is mounted on the device rest 1a, the user may experience inconvenience when controlling the device 1 to carry out operations.

The device 1 may determine that the device 1 is mounted on the device rest 1a when a predetermined condition is entered. The predetermined condition may be a horizontal mode (e.g., a wide mode or a landscape mode), a navigation running mode, or a car driving mode, of the device 1.

When the device 1 is mounted on the device rest 1a, the user gesture is captured by the image capture unit 10 to recognize the user located at a long distance, and the user gesture made within a reference range of the captured image is then recognized.

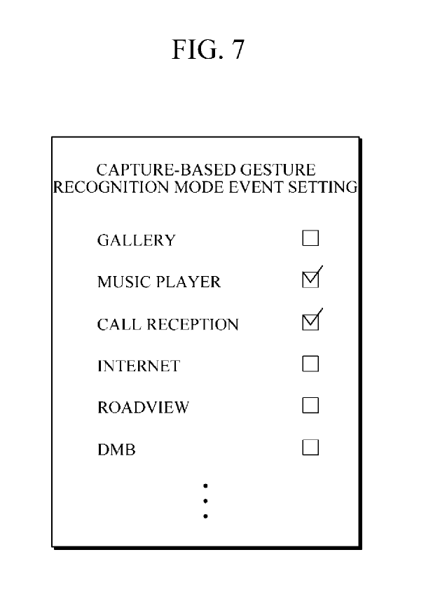

FIG. 7 is a reference diagram illustrating setting a capture-based gesture recognition mode event according to exemplary embodiments of the present invention.

The gesture recognition operation of the device 1 described with reference to FIGS. 1 and 2 may be enabled when the capture-based gesture recognition mode is entered, and may operate when an even set on the capture-based gesture recognition mode occurs. For example, when applications, such as a gallery application, a music player application, a call reception application, an internet browser, a roadview application, a digital multimedia broadcast (DMB) application, or the like, are executed as shown in FIG. 7, the device 1 may enter the capture-based gesture recognition mode.

The capture-based gesture recognition mode event may be set and changed by the user. For example, as shown in FIG. 7, when the user selects the music player and the call reception applications, the device 1 enters the capture-based gesture recognition mode at the time of executing the corresponding application. However, aspects need not be limited thereto such that the individual applications may include a setting within the application for entry into the capture-based gesture recognition mode, or a pop-up may be executed up on execution of the application to request whether the capture-based gesture recognition mode is to be entered.

FIGS. 8A and 8B are reference diagrams illustrating image screens in which gesture regions of the device 1 are determined according to exemplary embodiments of the present invention.

The gesture region determination unit 122 may first determine a first region in the captured image, and determines a second region within the determined first region. For example, the gesture region determination unit 122 primarily determines an upper body region of the user in the captured image as a first region 8-1 of FIG. 8A. The gesture region determination unit 122 recognizes the body of the user to determine the upper body region of the user. The gesture region determination unit 122 then determines the range of the user hand region in the upper body region as a second region 8-2 of FIG. 8A. The gesture region determination unit 122 detects the hand and determines that the user hand region, i.e., the second region 8-2, is the most likely location for a gesture to occur. A focal length of the image capture unit 10 may be determined or limited to the determined focal length when the hand region, i.e., the second region 8-2, is determined.

A portion having a large movement in the captured image is detected as the hand region, i.e., the second region 8-2. The hand region, i.e., the second region 8-2, may be defined by according to a blob feature technique. That is, the blob may be defined to include most of the skin color regions, and may be defined as the hand region as-is. The hand region, i.e., the second region 8-2, may be defined as a circle, and a centroid (x_c) of the hand region, i.e., the second region 8-2, may be obtained by a simple calculation. The hand region, i.e., the second region 8-2, may be defined as a circumscribed quadrilateral, and a size of the hand region h_size may be defined as an area of the circumscribed quadrilateral.

The gesture region determination unit 122 may first determine a first region in the captured image, and then determine a second region around the determined first region. However, a portion of the second region may be included in the first region. For example, as shown in FIG. 8B, the gesture region determination unit 122 first determines a face region of the user in the captured image as the first region 8-3. The gesture region determination unit 122 may recognize the face of the user as the first region 8-3. The gesture region determination unit 122 may then determine the user hand region around the face region as a second region 8-4 of FIG. 8B.

In order to detect the hand region, i.e., the second region 8-4, the gesture region determination unit 122 sets the region around the face as a region of interest when the face is recognized by the face recognition. For example, the gesture region determination unit may set regions around the first region 8-3, i.e., the determined face, as regions of interest. The regions of interest may include a Left (L) region, a Right (R) region, a Left Upper (LU) region, a Right Upper (RU) region, a Center Upper (CU) region, a Lower Left (LL) region, a Right Lower (RL) region, and a Center Lower (CL) region around the face, as regions of interest. The gesture region determination unit then determines user movements on the basis of the regions of interest. Although the regions of interest are described as including the L, R, LU, RU, CU, LL, RL, and CL regions, aspects need not be limited thereto such that more or fewer regions may be determined as regions of interest.

FIG. 9 is a diagram illustrating an image screen for setting a gesture region of a device 1 according to exemplary embodiments of the present invention.

The gesture region determination unit 122 determines a first region range 9-1 using a region including a specific user among a plurality of users, when the plurality of users is captured in the captured image. In this case, the region including the specific user may be determined by an auxiliary determination or input, including gesture recognition and/or voice recognition. For example, the specific user may be determined by a clapping movement or a clapping sound. However, aspects need not be limited thereto such that the specific user may be recognized according to a facial or other recognition method or operation.

The gesture region determination unit 122 may then determine a second region range 9-2 using the face region or the body region of the user through face recognition or body recognition in the first region range 9-1 including the specific user. In addition, the gesture region determination unit 122 may further determine a third region 9-3 in which the gesture occurs, for example, the hand region as shown in FIG. 9.

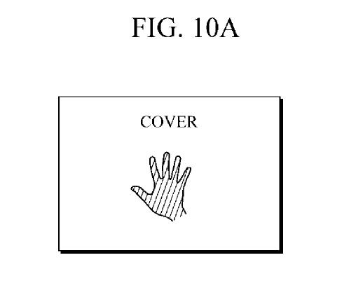

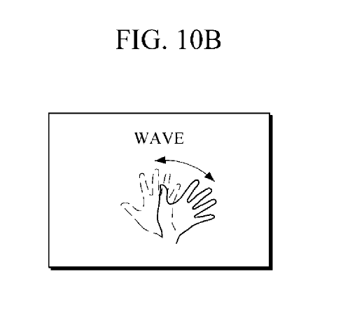

FIGS. 10A and 10B are diagrams illustrating user gesture recognition according to exemplary embodiments of the present invention.

The gesture recognition unit 124 may set specific gestures of the user as recognition targets. For example, the cover movement of FIG. 10A is a movement in which the user unfolds the palm toward the device, and the wave movement of FIG. 10B is a movement in which the user waves the hand side-to-side two or more times. The wave movement may be a gesture using the right arm or the left arm, depending on the user's practice. The gesture recognition unit 124 may define or determine a meaning for each specific gesture in a dictionary stored in the storage unit 16 as a table or a database, and may execute a corresponding instruction when the gesture is recognized. For example, the cover movement may be associated with instructions to pull, cover, stop, grasp, or the like, and the wave movement may be associated with instructions to turn over, punch, or the like. However, aspects need not be limited thereto such that the gesture movements and meanings described herein are only examples to aid in understanding the present disclosure.

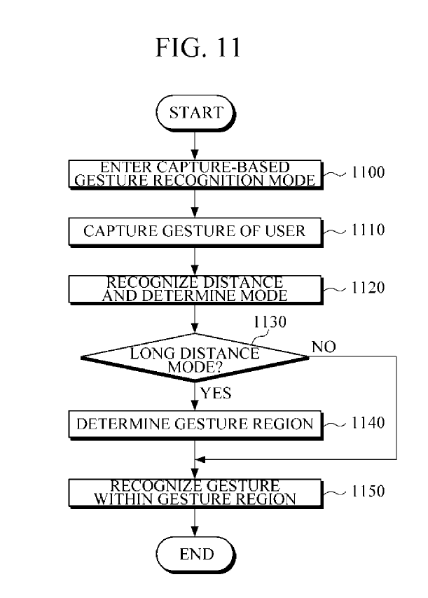

FIG. 11 is a flowchart illustrating a gesture recognition method of a device according to exemplary embodiments of the present invention.

The device 1 enters the capture-based gesture recognition mode (1100). Entering the capture-based gesture recognition mode may be executed when an event set on the capture-based gesture recognition mode occurs. For example, entering the capture-based gesture recognition mode may be executed when the device 1 is connected to another device or mounted on a device rest, or a specific application or command is executed. The capture-based gesture recognition mode event may be set and/or changed by the user. When the device enters the capture-based gesture recognition mode (1100), the device 1 captures the gesture of the user using the image capture unit 10 (1110).

The device then determines a distance between the device 1 and the user from the captured image, and determines a mode between the long distance mode and the short distance mode (1120).

In the mode determination (1120), the face and body are recognized in the captured image, and the mode may be determined as the short distance mode when the corresponding image includes only the face of the user, and the mode may be determined the long distance mode when the corresponding image includes the face and the body.

The mode determination (1120) may determine the mode as the short distance mode when a touch operation signal is received from the user, and may determine the mode as the long distance mode when a touch operation signal is not received from the user.

The mode determination (1120) may determine the mode as the short distance mode when the device 1 is not mounted on a device rest, and may determine the mode as the short distance mode when the device 1 is mounted on the device rest.

As a result of the mode determination (1120), the device 1 determines whether to operate in a long distance mode or a short distance mode (1130). If the device 1 determines to operate according to a long distance mode (1130), the gesture region in which the gesture of the user occurs in the captured image is determined (1140).

In the gesture region determination (1140), the device 1 may determine a first region in the captured image, and may determine a second region around the first region or within the first region on the basis of the determined first region. For example, the first region may be a face region or an upper body region of the user, and the second region may be a hand region of the user.

In the gesture region determination (1140), the device 1 may determine a third region including a specific person among a plurality of persons when the plurality of persons is captured in the captured image, and may determine the first region on the basis of the determined third region. Further, the device may determine the second region on the basis of the determined first region. The third region determination may be carried out by an auxiliary determination or input, including gesture recognition or voice recognition.

The device 1 then recognizes the user gesture within the gesture region determined by the gesture region determination (1140), and executes an instruction corresponding to the recognized gesture (1150).

If the device 1 determines to operate according to a short distance mode (1130), the device 1 may determine a gesture region, recognize a gesture in the gesture region, and execute an instruction corresponding to the recognized gesture (1150).

Aspects of the present disclosure may be implemented as computer-readable code recorded on a non-transitory, computer-readable recording medium. The non-transitory, computer-readable recording medium includes all types of recording media in which computer-readable data are stored. Examples of the non-transitory, computer-readable recording medium include a ROM, a RAM, a CD-ROM, a magnetic tape, a floppy disk, and an optical data storage. In addition, the non-transitory, computer-readable recording medium may be distributed to computer systems over a network, in which computer-readable codes may be stored and executed in a distributed manner.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A device to recognize a gesture of a user, the device comprising:
an image capture unit to capture a gesture to acquire image information;
a control unit to determine a distance between the device and the user based on the image information, and to determine a mode of the device according to the determined distance.

2. The device of claim 1, wherein the image capture unit captures the gesture in a capture-based gesture recognition mode.

3. The device of claim 2, wherein the device enters the capture-based gesture recognition mode according to at least one of establishing a connection to another device, mounting the device on a device rest, and an execution of at least one of a gallery application, a music player application, a call reception application, an internet browser application, a roadview application, and a digital multimedia broadcast application.

4. The device of claim 1, wherein the control unit comprises:
a distance determination unit to determine whether to operate the device in a short distance mode or a long distance mode.

5. The device of claim 4, wherein the distance determination unit determines to operate in the short distance mode if the distance determination unit determines that the image information includes only a face of the user.

6. The device of claim 4, wherein the distance determination unit determines to operate in the long distance mode if the distance determination unit determines that the image information includes a face and a body of the user.

7. The device of claim 4, wherein the control unit further comprises a gesture determination unit to determine a first region associated with a body of the user, and a second region associated with a hand of the user, the second region being within the first region.

8. The device of claim 1, wherein the control unit comprises a gesture determination unit to determine a first region associated with a body of the user, and a second region associated with a hand of the user, the second region being adjacent to the first region.

9. The device of claim 1, wherein the control unit comprises a gesture determination unit to determine a first region associated with the user from among a plurality of users, a second region within the first region associated with a body and a face of the user from among a plurality of users.

10. The device of claim 9, wherein the gesture determination unit determines a third region associated with a hand of the user from among the plurality of users.

11. The device of claim 10, wherein the gesture determination unit determines the first region according to at least one of a gesture recognition, a voice input, a clapping movement, and a clapping sound associated with the user.

12. A method for recognizing a gesture for a device, the method comprising:
capturing a gesture of a user as image information;
determining a distance between the device and the user based on the image information; and
determining a mode of operation according to the determined distance.

13. The method of claim 12, further comprising:
entering a capture-based gesture recognition mode according to at least one of establishing a connection to another device, mounting the device on a device rest, and executing at least one of a gallery application, a music player application, a call reception application, an interne browser application, a roadview application, and a digital multimedia broadcast application.

14. The method of claim 12, wherein the mode of operation is determined to be a short distance mode if only a face of the user is determined to be included in the image information.

15. The method of claim 12, wherein the mode of operation is determined to be a long distance mode if a face and a body of the user is determined to be included in the image information.

16. The method of claim 15, further comprising:
in the long distance mode, determining a first region associated with the face and the body of the user, determining a second region associated with a hand of the user, the second region being included in or adjacent to the first region, and determining a gesture occurring in the second region.

17. The method of claim 15, further comprising:
in the long distance mode, determining a first region associated with the user from among a plurality of users, determining a second region associated with the face and the body of the user, determining a third region associated with a hand of the user, and determining a gesture occurring in the third region.

18. A method for recognizing a gesture for a device, the method comprising:
entering a capture-based gesture recognition mode according to at least one of establishing a connection to another device, mounting the device on a device rest, and executing an application;
capturing a gesture of a user as image information;
determining a distance between the device and the user based on the image information;
determining a mode of operation of the device based on the determined distance; and
determining regions of the image information associated with a gesture if the mode of operation of the device is determined to be a long distance mode.

19. The method of claim 19, wherein the determined regions comprise at least one of a first region associated with the user from among a plurality of users, a second region associated with a face and a body of the user, and a third region associated with a hand of the user, the third region being within or adjacent to a region associated with the face and the body of the user.
